(19) United States
(12) Patent Application Publication
(10) Pub. No.: US 2009/0275707 A1
(43) Pub. Date: Nov. 5, 2009

(54) PROCESS FOR PREPARING HALOGEN-FREE ATRP PRODUCTS

(75) Inventors: Sven Balk, Frankfurt (DE); Gerd Löhden, Essen (DE); Elke Osthaus, Gummersbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/304,275

(22) PCT Filed: May 15, 2007
(86) PCT No.: PCT/EP2007/054670

§ 371 Date: Dec. 11, 2008

(30) Foreign Application Priority Data
Aug. 9, 2006 (DE) 10 2006 037 350.2

(51) Int. Cl. C08L 67/00; C08G 75/02

(52) U.S. Cl. 525/418; 528/364

(57) ABSTRACT

The present invention relates to the in situ removal of terminal halogen atoms from polymer chains which have been prepared by means of atom transfer radical polymerization, and to the simultaneous removal of transition metals from polymer solutions.

### FIELD OF THE INVENTION

The present invention relates to the in-situ removal of terminal halogen atoms from polymer chains prepared by atom transfer radical polymerization (hereinafter abbreviated to ATRP). The present invention also encompasses a process for the removal of transition metals from polymer solutions. Specifically, this involves the removal of transition metal complexes with content extending as far as 1000 ppm. Very specifically, it involves the removal of transition metal complexes, mostly containing, from polymer solutions after a completed atom transfer radical polymerization.

One very particular aspect of the present invention is that the addition of a reagent simultaneously achieves, in one process step, removal of the terminal halogen atoms from the polymer chains, optionally a functionalization of the polymer termini, removal of the transition metal compounds by precipitation, and salt formation from the ligands previously coordinated on the transition metal, this salt formation in turn permitting simple removal of these same entities.

ATRP is an important process for preparation of a wide variety of polymers, e.g. polyacrylates, polymethacrylates or polystyrenes. This type of polymerization has provided considerable progress toward the objective of tailored polymers. The ATRP method was substantially developed by Prof. Matyjaszewski (Matyjaszewski et al., J. Am. Chem. Soc., 1995, 117, p. 5614; WO 97/18247; Science, 1996, 272, p. 866). ATRP provides narrowly distributed (homo)polymers in the molar mass range of Mₙ=5000-120 000 g/mol. One particular advantage here is that it is possible to control not only the molecular weight but also the molecular weight distribution. This is moreover a living polymerization which permits the targeted construction of polymer architectures, examples being random copolymers or block copolymer structures. Appropriate initiators can, for example, also give unusual block copolymer and star polymers. Theoretical principles of the polymerization mechanism are explained inter alia in Hans Georg Elias, Makromoleküle [Macromolecules], volume 1, 6th edition, Weinheim 1999, p. 344.

### PRIOR ART

The development of an ATRP process step in which, simultaneously, the halogen at the end of the polymer chain is removed, the transition metal is simultaneously completely precipitated, the ligand is converted to an ionic form which is easy to remove, and optionally a functionalization of the chain ends can be undertaken is certainly not prior art. Indeed, this is true simply for the combination of halogen removal and simultaneous transition metal precipitation and, respectively, functionalization and transition metal precipitation.

The present invention moreover provides respectively and individually a marked improvement and with the prior art in relation both to halogen removal and to transition metal precipitation. Since a combination of the two functions is not yet within the prior art, these two aspects are described separately below.

The ATRP process is based on a redox equilibrium between a growing radical polymer chain present only at low concentration and a transition metal compound in a higher oxidation state (e.g. copper II), and the dormant combination preferably present composed of the polymer chain terminated by a halogen or by a pseudohalogen and the corresponding transition metal compound in a lower oxidation state (e.g. copper I). This applies both to actual ATRP, which is initiated using (pseudo)halogen-substituted initiators and to reverse ATRP as described at a later stage below, in which the halogen is not bonded to the polymer chain until the equilibrium is established. Irrespective of the process selected, the halogen atom remains at the respective chain ends after termination of the reaction. These terminal halogen atoms have many possible uses. Many specifications describe the use of this type of polymer as macroinitiator after purification or via sequential addition of further monomer fractions for the construction of block structures. A representative example to which reference may be made is U.S. Pat. No. 5,807,937 for sequential polymerization and U.S. Pat. No. 6,512,060 for the synthesis of macroinitiators.

However, a problem is that, as is well known to the person skilled in the art, these halogen-functionalized polymers are thermally unstable. This is one of the disadvantages of prior-art ATRP. In particular, polymethacrylates or polyacrylates prove to be markedly susceptible to depolymerization when terminal halogen atoms are present. A method for removal of said terminal halogen atoms is therefore of great interest. A widely used process is based on the substitution of the halogens by metal alcoholates, with precipitation of the resultant metal halide. This type of process is described by way of example in US 2005/090632. Disadvantages of said procedure are that the metal alcoholates have limited availability, and are costly, and that the process can only be carried out after purification of the polymers.

There are also other known processes for the substitution of the terminal halogen groups. However, azides (see Matyjeszewski et al., Macromol. Rapid Commun, 18, 1057-66. 1997) and phosphines (Coessens, Matyjaszewski, Macromol. Sci. Pure Appl. Chem., 36, 653-666, 1999) lead to incomplete conversions, are toxicologically very hazardous, and are expensive. These processes can moreover only be used in a polymer-analogous reaction, after product work-up.

The invention uses a mercaptan, such as methyl mercaptan or n-dodecyl mercaptan, for the substitution of the terminal halogen atoms. The mercaptan can certainly also bear other functionalities. Thioglycolic acid or mercaptoethanol are examples here. The only brief description of this type of substitution reaction is found in Snijder et al. (J. of Polym. Sci.: Part A: Polym. Chem.). The objective of that scientific publication was the functionalization of the chain ends by OH groups. The removal of the bromine atoms, which in this instance are terminal, has to be considered only as a side effect providing a route to the objective. The reaction is therefore described exclusively with mercaptoethanol as reagent. No mention is made of any substitution with unfunctionalized, or acid- or amine-, or epoxy-functionalized, mercaptans. Another difference from the present invention is the polymer-analogous conduct of the reaction. In the publication described, the substitution reaction is carried out only after purification of the ATRP product, in a second reaction stage. This directly gives a third important difference from the present invention. The effect of the invention: the precipitation of the transition metal compounds from the ATRP solution through addition of mercaptan reagents, is not described in said publication.

WO 00/34345 and Heuts et al. (Macromol. Chem. Phys., 200, 1380-5, 1999) describe conductive ATRP with initial addition of n-dodecyl mercaptan and, respectively, octyl mercaptan. In both instances, although relatively stable, probably halogen-free, polymers are described, there are also indications that polydispersity is greater than 1.6, therefore being very similar to that of a free-radically polymerized material. The advantages of ATRP, narrowly distributed products and control of the architecture of the polymer, are thus not available. Irrespective of this, no precipitation of the transition metal compounds is mentioned in the procedure described. This is probably attributable to a choice, fundamentally differing from the present invention, of less basic ligands.

WO 2005/098415 describes substitution of the terminal halogen atoms on polystyrenes, carried out by a polymer-analogous method, i.e. after purification of the polymer. Here, substitution takes place only at one chain end with thiourea, and with subsequent quenching by sodium hydroxide to give sodium sulfide groups. These products are prepolymers for linking to substrate materials. The products are used as filler materials for chromatography columns. Again, said specification differs not only in that two stages are used, in that substitution is only monolateral, and in that the mechanism is fundamentally different, but also the lack of any relevance to product work-up. The substitution described in said document is moreover claimed not only with respect to ATRP polymers but also with respect to RAFT polymers and NMP polymers (nitroxide-mediated polymerization).

One of the few descriptions of in-situ methods is found in Schön et al. (Macromolecules, 34, 5394-7, 2001). Here, the polydentate amine ligand needed in the ATRP (in this instance trifunctional PMDETA) is used in double-equivalent excess with regard to the copper reagent. Toward the end of the polymerization, the ligand substitutes the halogen by way of a mechanism not described in any detail with hydrogen. However, a disadvantage here is firstly the very high ligand concentration, which can discolor the product, and which makes copper removal even more difficult. Secondly, the process is described only for bulk ATRP, which is almost impossible to carry out industrially. The same method, also in solution, is described in Pionteck et al. (Marcomol. Symp., 210, 147-155, 2004, and Macromol. Chem. Phys., 205, 2356-65, 2004). However, they describe amine groups at the end of the polymer and refer to very high polydispersities >2, this being a further disadvantage. These also occur during attempts at a solution polymerization, and eliminate the major advantage of control of the ATRP reaction.

An alternative is the use of stable radicals, such as nitroxides (see, for example: Beyou et al., Macromol. Chem. Phy., 202, 974-9, 2001) to trap the chain ends temporarily present in free-radical form, or to use targeted recombination of the radical chain ends for this purpose. Both processes require additional, time-consuming intervention in the polymerization process—e.g. temperature increases. The person skilled in the art can moreover readily see that said process neither facilitates catalyst removal nor can lead to ATRP-type polymers with narrow molecular weight distributions. Said method is often termed ATRA (Atom Transfer Radical Addition) in the literature. A variant of ATRA is the addition of reagents which decompose in situ to give two radicals, of which one in turn irreversibly traps a radical chain end and the second can initiate new smaller chains. A disadvantage of this procedure, alongside the reaction rate, which is again reduced, is the poor commercial availability of the reagents required and the liberation of additional radicals, which either have to be trapped very rapidly or else lead to undesired oligomeric byproducts. Said process is described by way of example in the work of Sawamoto (Macromolecules, 31, 6708-11, 1998, and J Polym. Sci. Part A: Polym. Chem., 38, 4735-48, 2000).

The prior art in relation to the removal of transition metal compounds from the ATRP solution is as follows:

Purification of polymers or polymer solutions is widely described. By way of example, low-molecular-weight compounds can be removed from solutions or else from solid polymers by extraction processes. This type of process is described in general terms by way of example in WO 02/28916. However, if almost complete removal of transition metal complexes from a polymer solution is to be achieved—i.e. to a content of 1 ppm—extraction alone is not a suitable method. But for various reasons great importance is placed on the almost complete removal of said compounds. Firstly, transition metals have a particularly strong color, in particular if surrounded by coordinative ligands, and in many applications coloring of the final product is undesirable. Excessive concentrations of transition metals can moreover exclude applications related to contact with food or drink, or cosmetic applications. Relevant concentrations are also very likely to reduce product quality: firstly, metal content can catalyze depolymerization and thus reduce the thermal stability of the polymer, and secondly coordination of functional groups of the polymer can significantly increase melt viscosity or solution viscosity.

Ligands introduced with the transition metal can also cause undesired side effects. Many of these highly coordinative compounds, e.g. the di- or trifunctional amines widely used in ATRP, act as catalyst poison in downstream reactions, e.g. hydrosilylation. It is therefore not only the removal of the transition metal per se which is of great interest: maximum efficiency of ligand concentration reduction during work-up is also important. Processes which work by destroying the transition metal complex and exclusively removing the metal are therefore inadequate for many downstream reactions and applications. Another reason for this is that many of these ligands have strong odor and strong color.

One specific form of extraction is aqueous liquid-liquid extraction from polymer solutions. By way of example, a copper catalyst is used during the synthesis of polyphenylene oxide, and is removed from the polymer solution by aqueous extraction after the polymerization (cf. Ullmanns Encyclopedia of Industrial Chemistry, 5th edition 1992, vol. 26 a, pp. 606 ff). A disadvantage of this method is that many polar polymers act as suspension stabilizers and inhibit separation of the two liquid phases. These methods cannot therefore be used, for example, for work-up of polymethyl methacrylates. Another disadvantage is that transfer of this type of process to industrial-scale production is very complicated.

On a laboratory scale, the transition metal compound—e.g. a copper catalyst—is mostly removed from polymer solutions through adsorption on aluminum oxide and subsequent precipitation of the polymer in suitable precipitants, or through direct precipitation without an adsorption step. Particularly suitable precipitates are highly polar solvents, such as methanol. Given appropriate surrounding ligands, however, it is also possible to use particularly non-polar precipitants, such as hexane or pentane, but this type of procedure is disadvantageous for various reasons. Firstly, precipitation does not give the polymer in a uniform condition, as is the case with a granulated material, for example. This makes removal, and thus further work-up, difficult. Furthermore, the precipitation process produces large amounts of the precipitant, mixed with the solvents, the catalyst residues, and other constituents requiring removal, e.g. residual monomers. These mixtures require complicated separation in downstream processes. Precipitation processes in their entirety are therefore not transferable to industrial-scale production, and useful only on laboratory scale.

There are moreover known processes in which a solid catalyst is separated from the liquid polymer-containing solution. Here, the catalyst itself becomes insoluble, for example through oxidation, or is bound, prior to or after the polymerization, to a solid absorbent or to a swollen, but insoluble resin. The liquid polymer-containing phase is separated from the insoluble material by filtering or centrifuging. By way of example, CN 121011 describes a process in which an adsorbent (in particular activated charcoal or aluminum oxide) is added to the polymer solution after the ATRP process, and is then removed by filtering. A disadvantage here is that very large amounts of adsorbent are needed to achieve complete removal, although the content of transition metal complexes in the reaction mixture is relatively small. The use of aluminum oxide is also claimed in JP 2002 363213. JP 2005 015577, JP 2004 149563, and other specifications use basic or acidic silica. JP 2003 096130, JP 2003 327620, JP 2004 155846, and a number of other patent specifications from Kaneka (or Kanegafuchi) use acidic or basic adsorbents or combinations of hydrotalcites as adsorbents, in filtration processes which are mostly multistage processes. Here again, large amounts of the inorganic material are used. These adsorbents are moreover relatively expensive and require very complicated recycling. Lack of cost-effectiveness is particularly significant when ion exchanger materials are used (cf. Matyjazewski et al., Macromolecules, 2000, 33(4), pp. 1476-8).

This same effect described is also the basis of the patent DE 100 15 583, which describes an ATRP process in non-polar solvents. The transition metal complex becomes insoluble during or after the reaction, through oxidation, and can be removed by filtration. However, processes of this type are suitable only for the preparation of relatively non-polar polymers. If polar polymers are prepared, for example polymethyl methacrylates, the polymers are insoluble in the solvent. This procedure therefore has only very restricted applicability, in very specific polymerizations. The product range available via this procedure can be further broadened by targeted “design” of the ligands, which lead to insolubility of the transition metal complex under work-up conditions—this is described by way of example in Liou et al., Polym. Prep. (Am. Chem. Soc., Div. Poly. Chem.; 1999, 40(2), p. 380). By analogy with this, JP 2005 105265 adds an additional complexing agent to alter solubility, with EDTA. The very high prices of the ligands are a disadvantage. The person skilled in the art can moreover readily see that all of the processes based on precipitation which is ancillary to the process with no addition of any precipitant can only lead to incomplete catalyst removal. Most prior-art processes are therefore multistage processes involving addition of auxiliaries, which mostly function as adsorbents. Corresponding disadvantageous work-ups with phase separation are also found in JP 2002 356510.

These multistage processes often use centrifuging. This process cannot be cost-effectively extended to industrial production volumes. Stages of this type are described in EP 1 132 410 or JP 2003 119219.

### OBJECT

It is an object of the present invention to prepare polymers by atom transfer radical polymerization (ATRP) which contain no, or only traces of, halogens or pseudohalogens. Another object here is to improve the thermal stability of said polymers in comparison with halogen-containing products.

A particular object of this invention is to realize polymers which, with the exception of the end groups, correspond entirely to the materials which can be prepared by ATRP in the prior art.

Another object of this invention is to carry out the halogen removal within the context of a process which is cost-effective and simple to realize industrially. A very particular object is to carry out the halogen removal without additional product work-up directly at the end of the actual ATRP process in the same reaction vessel (one-pot reaction).

A parallel object of this invention, in the light of the prior art, is to provide a process which is realizable industrially and which can remove transition metal complexes from polymer solutions. At the same time, the novel process is intended to be inexpensive and fast. Another object of the present invention was to provide a process which can be implemented on known systems suitable for solution polymerization, without complicated reengineering. Another object was to realize particularly low residual concentrations of the transition metal complex compounds, below 5 ppm, after just one filtration step.

A particular object of the present invention was to remove transition metal residues from solutions from an ATRP polymerization, after termination of the polymerization.

### ACHIEVEMENT OF OBJECT

The object was achieved via a process for the removal of halogen atoms from polymers and removal of transition metal compounds, characterized in that the halogen atoms are substituted by addition of a suitable sulfur compound and simultaneously the transition metal compounds are precipitated by said sulfur compound, and are then removed by filtration.

The suitable sulfur compounds are added after or during termination of the polymerization. These sulfur compounds simultaneously serve a plurality of purposes. Firstly, the terminal halogen atoms on the polymer chains are substituted and thus removed from the polymers. Secondly, a reagent is thus produced which is suitable to cause quenching of the transition metal compound, thus causing almost complete precipitation of the metal. This can easily be removed by filtration.

The detailed result of addition of mercaptans to halogen-terminated polymer chains, as are present during or at the end of an ATRP process is substitution of the halogen. A thioether group thus forms at the end of the polymer chain, this being a group previously known from free-radical polymerization using sulfur-based regulators. A hydrogen halide is formed as cleavage product.

The choice of the regulator also permits introduction of further functionalities, such as hydroxy or acid groups, at the end of the polymer chain.

The hydrogen halide that forms cannot be hydrolyzed in organic polymerization solutions, and thus has particular reactivity, leading to protonation of the ligands described below, mostly basic, on the transition metal compound. This quenching of the transition metal complex proceeds extremely rapidly and gives direct precipitation of the transition metal compounds, which are not then subject to any masking effect.

One very particular aspect of the present invention is that the addition of a reagent in one process step simultaneously causes removal of the terminal halogen atoms from the polymer chains, optionally a functionalization of the polymer termini, removal of the transition metal compounds by precipitation, and salt formation from the ligands previously coordinated on the transition metal, this salt formation in turn permitting simple removal of the ligands.

In the ATRP process described, termination of the reaction mostly takes place through oxidation of the transition metal. This can take place quite simply by introducing atmospheric oxygen or by addition of sulfuric acid. In the case of copper as catalyst, a portion of the metal complex often precipitates during this established procedure. However, this proportion is not adequate for further processing of the polymer. The object of optimized catalyst removal has been achieved by using protonation for the efficient removal described of the ligands coordinated on the transition metal. This protonation is an indirect result of addition of sulfur compounds, e.g. mercaptans.

Another constituent of this invention is that the sulfur compounds used become almost completely bonded to the polymer chains, and that the residual sulfur content can be removed completely and quite simply by simple modifications of the filtration process. This method gives products which have no unpleasant odor caused by sulfur compounds.

One great advantage of the present invention is the efficient removal of the transition metal complexes from the solution. Through application of the process of the invention it is possible to use a filtration process to reduce transition metal content by at least 80%, preferably by at least 95%, and very particularly preferably by at least 99%. In particular embodiments, indeed, application of the process of the invention permits reduction of transition metal content by more than 99.9%.

Surprisingly, it has moreover been found that, based on the chain ends, only a minimal excess of 1.6 equivalents of corresponding sulfur compounds has to be used, preferably 1.2 equivalents, and particularly preferably less than 1.1 equivalents. The result of this minimal excess is a residual sulfur content which is per se very low in the polymer solution, and which can easily be removed by modification of the subsequent filtration step.

The reagents added to the polymer solution in the invention after or during termination of the polymerization preferably involve compounds containing sulfur in organically bonded form. It is particularly preferable that these sulfur-containing compounds used for the precipitation of transition metal ions or of transition metal complexes have SH groups. Very particularly preferred organic compounds that may be mentioned are mercaptans and/or other functionalized or else non-functionalized compounds which have one or more thiol groups and/or can form corresponding thiol groups under the conditions in the solution. These can involve organic compounds, such as thioglycolic acetic acid, mercaptopropionic acid, mercaptoethanol, mercaptopropanol, mercaptobutanol, mercaptohexanol, octyl thioglycolate, methyl mercaptan, ethyl mercaptan, butyl mercaptan, dodecyl mercaptan, isooctyl mercaptan, and tert-dodecyl mercaptan. Most of the examples listed involve compounds which are readily available commercially and used as regulators in free-radical polymerization. However, the present invention is not restricted to said compounds, the deciding factor rather being that the precipitant used has an —SH group or forms an —SH group in situ under the conditions prevailing in the polymer solution.

A particularly surprising finding was that said sulfur compounds used can comprise compounds known as regulators in free-radical polymerization. Advantages of these compounds are their ready availability, their low price, and the possibility of wide variation, permitting ideal matching of the precipitation reagents to the respective polymerization system. Regulators are used in free-radical polymerization in order to control the molecular weight of the polymers.

The amount of regulators in free-radical polymerization, based on the monomers to be polymerized, is mostly given as from 0.05% by weight to 5% by weight. In the present invention, the amount of the sulfur compound used is not based on the monomers, but on the concentration of the transition metal compound in the polymer solution. In this sense, the amount used of the sulfur-containing precipitants of the invention is 1.5 molar equivalents, preferably 1.2 molar equivalents, particularly preferably less than 1.1 molar equivalents, and very particularly preferably less than 1.05 molar equivalents.

The person skilled in the art can readily see that the mercaptans described, when added to the polymer solution, after termination of the polymerization, cannot have any further effect on the polymers beyond the substitution reaction described. This applies in particular to the molecular weight distributions, the molecular weight, additional functionalities, glass transition temperatures or melting points in the case of semicrystalline polymers, and the architecture of the polymers, for example branching or block structures.

The person skilled in the art can moreover readily see that a corresponding process based in terms of apparatus exclusively on filtration of the polymer solution can readily be used as an industrial process on existing solution polymerization systems, without any major reengineering.

A further advantage of the present invention is that the reduction to one or at most two filtration steps permits very rapid work-up of the polymer solution in comparison with many established systems.

The substitution, and the precipitation and subsequent filtration moreover take place at a temperature in the range from 0° C. to 120° C., these being process parameters within a familiar range.

A further field of the invention is the efficient, simultaneous removal of the ligands, which by way of example in the case of amine compounds take the form of ammonium halides. These ionic ammonium halides are likewise precipitated in organic solvents and can be removed simultaneously in the filtration of the transition metal compounds. In the case of particularly non-polar ligands, there can be some delay to the precipitation of the ammonium salts. In this case, a second filtration step would be needed after the filtrate has undergone some degree of aging.

Compounds used as initiator in ATRP are those having one or more atoms or atom groups X which can undergo free-radical transfer under the polymerization conditions of the ATRP process. Substitution of the active group X at the respective chain end of the polymer liberates an acid of X—H type. It has been found that this acid directly protonates the ligand L and thus quenches the metal-ligand complex. The transition metal is thus generally precipitated in the form in which it was used at the start of the polymerization: e.g. in the case of copper in the form of CuBr, CuCl, or Cu₂O. If the conditions are such that the transition metal is simultaneously oxidized, e.g. through introduction of air, the transition metal compound also precipitates in the higher oxidation state. The maximum excess that has to be used of said sulfur compound in the invention in order to achieve said effect, based on the active group X at the end of the polymer chain, is only, for example, 1.1 equivalents. A corresponding situation applies, based on the ligands L: for complexes in which the transition metal and the ligand are present in the ratio 1:1, just a very slight excess of the sulfur compound is likewise sufficient to achieve complete quenching of the transition metal complex. Examples of these ligands are N,N,N′,N″,N″-pentamethyldiethylenetriamine (PMDETA) and tris(2-aminoethyl)amine (TREN), which are described below. In the case of ligands present in the complex in a bioequivalent ratio with respect to the transition metal, this invention is applicable only when the transition metal is used in a marked excess of, for example, 1:2 with respect to the active groups X. 2,2′-bipyridine is an example of this type of ligand.

As an alternative to a second filtration step, the first filtration can be modified. The ammonium salts can be immobilized through addition of suitable absorbents, e.g. aluminum oxide, silica, hydrotalcite, or ion-exchanger resins. Insoluble organic polyacids, such as polyacrylic acid or polymethacrylic acid, or insoluble polymethacrylates or polyacrylates with high acid content or a mixture thereof, or a mixture thereof with the inorganic compounds listed above. In contrast to the use in the prior art of adsorbents which are often identical, the corresponding auxiliaries are only optionally used in the process of the invention. Furthermore, the amounts needed of said auxiliaries are markedly smaller in comparison with the prior-art processes described. All that is needed for their removal is moreover an additional filtration step, or else they can be removed simultaneously in the same filtration step with the removal of the precipitated transition metal compounds.

Another possibility, as an alternative, is extraction of the solution, which is carried out in advance or else subsequently, for example with water or buffer solution.

As the person skilled in the art can readily see, said process for ligand removal can also be transferred to non-amine-based systems.

Adsorbents or adsorbent mixtures can be used to reduce the amounts of the final traces of sulfur compounds and/or ligands. This can take place in parallel or in successive work-up steps. The adsorbents are known from the prior art and preferably selected from the group of silica and/or aluminum oxide, organic polyacids, and activated charcoal (e.g. Norit SX plus from Norit).

The removal of the activated charcoal, too, can take place in a separate filtration step or in a filtration step simultaneous with transition metal removal. In one particularly efficient variant, the activated charcoal is not added in the form of solid to the polymer solution, but the filtration takes place through activated-charcoal-loaded filters, which are commercially available (e.g. AKS 5 from Pall Seitz Schenk). A combination of addition of the acidic auxiliaries described above and activated charcoal can also be used, as also can addition of the auxiliaries described above and filtration through an activated-charcoal-loaded filter.

The present invention provides the removal of the terminal halogen atoms and of the transition metal complexes from any of the polymer solutions produced by ATRP processes. The possibilities resulting from ATRP are briefly outlined below. However, these lists do not provide a limiting description of ATRP and thus of the present invention. Instead, they serve to indicate the major importance and versatility of ATRP and thus also of the present invention, for the work-up of appropriate ATRP products:

The monomers that can be polymerized by means of ATRP are well known. A few examples are listed below, but with no intention of placing any type of restriction on the present invention. The term (meth)acrylate here means the esters of (meth)acrylic acid, its meaning here being not only methacrylate, e.g. methyl methacrylate, ethyl methacrylate, etc., but also acrylate, e.g. methyl acrylate, ethyl acrylate, etc., and also mixtures of the two.

Monomers which are polymerized are selected from the group of the (meth)acrylates, such as alkyl (meth)acrylates of straight-chain, branched, or cycloaliphatic alcohols having from 1 to 40 carbon atoms, e.g. methyl (meth)acrylate, ethyl (meth)acrylate, n-butyl (meth)acrylate, isobutyl (meth)acrylate, tert-butyl (meth)acrylate, pentyl (meth)acrylate, 2-ethylhexyl (meth)acrylate, stearyl (meth)acrylate, lauryl (meth)acrylate, cyclohexyl (meth)acrylate, isobornyl (meth)acrylate; aryl (meth)acrylates, e.g. benzyl (meth)acrylate or phenyl (meth)acrylate, which respectively may be unsubstituted or may have mono- to tetrasubstituted aryl moieties; other aromatically substituted (meth)acrylates, such as naphthyl (meth)acrylate; mono(meth)acrylates of ethers, of polyethylene glycols, of polypropylene glycols, or their mixtures having from 5 to 80 carbon atoms, e.g. tetrahydrofurfuryl methacrylate, methoxy(m)ethoxyethyl methacrylate, 1-butoxypropyl methacrylate, cyclohexyloxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol) methyl ether (meth)acrylate, and poly(propylene glycol) methyl ether (meth)acrylate. The monomer selection can also encompass respective hydroxy-functionalized and/or amino-functionalized and/or mercapto-functionalized and/or olefinically functionalized acrylates and, respectively, methacrylates, e.g. allyl methacrylate or hydroxyethyl methacrylate.

Alongside the (meth)acrylates set out above, the compositions to be polymerized can also comprise other unsaturated monomers which are homopolymerizable or copolymerizable with the abovementioned (meth)acrylates and by means of ATRP.

Among these are, inter alia, 1-alkenes, such as 1-hexene, 1-heptene, branched alkenes, such as vinylcyclohexane, 3,3-dimethyl-1-propene, 3-methyl-1-diisobutylene, 4-methyl-1-pentene, acrylonitrile, vinyl esters, e.g. vinyl acetate, styrene, substituted styrenes having an alkyl substituent on the vinyl group, e.g. α-methylstyrene and α-ethylstyrene, substituted styrenes having one or more alkyl substituents on the ring, e.g. vinyltoluene and p-methylstyrene, halogenated styrenes, such as monochlorostyrenes, dichlorostyrenes, tribromostyrenes, and tetrabromostyrenes; heterocyclic compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, 9-vinylcarbazole, 3-vinylcarbazole, 4-vinylcarbazole, 2-methyl-1-vinylimidazole, vinyloxolane, vinylfuran, vinylthiophene, vinylthiolane, vinylthiazoles, vinyloxazoles, and isoprenyl ethers; maleic acid derivatives, such as, maleic anhydride, maleimide, methylmaleimide, and dienes, e.g. divinylbenzene, and also the respective hydroxy-functionalized and/or amino-functionalized and/or mercapto-functionalized and/or olefinically functionalized compounds. The manner of preparation of these copolymers can also be such that they have a hydroxy and/or amino and/or mercapto functionality, and/or an olefinic functionality, in a substituent. Examples of these monomers are vinylpiperidine, 1-vinylimidazole, N-vinylpyrrolidone, 2-vinylpyrrolidone, N-vinylpyrrolidine, 3-vinylpyrrolidine, N-vinylcaprolactam, N-vinylbutyrolactam, hydrogenated vinylthiazoles, and hydrogenated vinyloxazoles. It is particularly preferable to copolymerize vinyl esters, vinyl ethers, fumarates, maleates, styrenes, or acrylonitriles with the A blocks and/or B blocks.

The process can be carried out in any desired halogen-free solvent. Preference is given to toluene, xylene, acetates, preferably butyl acetate, ethyl acetate, propyl acetate; ketones, preferably ethyl methyl ketone, acetone; ethers; aliphatics, preferably pentane, hexane; alcohols, preferably cyclohexanol, butanol, hexanol, or else biodiesel.

Block copolymers of constitution AB can be prepared by sequential polymerization. Block copolymers of constitution ABA or ABCBA are prepared by sequential polymerization and initiation using bifunctional initiators.

The ATPR can be carried out in the form of emulsion polymerization, miniemulsion polymerization, microemulsion polymerization, or suspension polymerization, as well as in the form of solution polymerization.

The polymerization can be carried out at atmospheric pressure, subatmospheric pressure, or superatmospheric pressure. The polymerization temperature is also non-critical. However, it is generally in the range from −20° C. to 200° C., preferably from 0° C. to 130° C., and particularly preferably from 50° C. to 120° C.

The number-average molar mass of the polymers obtained in the invention is preferably from 5000 g/mol to 120 000 g/mol, particularly preferably ≦50 000 g/mol, and very particularly preferably 7500 g/mol to 25 000 g/mol.

Polydispersity has been found to be below 1.8, preferably below 1.6, particularly preferably below 1.4, and ideally below 1.2.

The initiator used can comprise any compound which has one or more atoms or, respectively, atom groups X which can be transferred by a radical route under the polymerization conditions of the ATRP process. The active group X generally involves Cl, Br, I, SCN, and/or N₃. Suitable initiators generally encompass the following formulae:

R¹R²R³C—X, R¹C(═O)—X, R¹R²R³Si—X, R¹NX₂, R¹R²N—X, (R¹)ₙP(O)ₘ—X₃₋ₙ, (R¹O)ₙP(O)ₘ—X₃₋ₙ, and (R¹)(R²O)P(O)ₘ—X,

where X has been selected from the group consisting of Cl, Br, I, OR⁴, SR⁴, SeR⁴, OC(═O)R⁴, OP(═O)R⁴, OP(═O)(OR⁴)₂, OP(═O)OR⁴, O—N(R⁴)₂, CN, NC, SCN, NCS, OCN, CNO, and N₃ (where R⁴ is an alkyl group of from 1 to 20 carbon atoms, where each hydrogen atom independently can have been replaced by a halogen atom, preferably fluoride or chloride, or alkenyl of from 2 to 20 carbon atoms, preferably vinyl, or alkenyl of from 2 to 10 carbon atoms, preferably acetylenyl, or phenyl, in which from 1 to 5 halogen atoms or alkyl groups having from 1 to 4 carbon atoms can be present as substituents, or aralkyl, and where R¹, R², and R³, independently of one another, have been selected from the group consisting of hydrogen, halogens, alkyl groups having from 1 to 20, preferably from 1 to 10, and particularly preferably from 1 to 6, carbon atoms, cycloalkyl groups having from 3 to 8 carbon atoms, silyl groups, alkylsilyl groups, alkoxysilyl groups, amine groups, amide groups, COCl, OH, CN, alkenyl groups or alkynyl groups having from 2 to 20 carbon atoms, preferably from 2 to 6 carbon atoms, and particularly preferably allyl or vinyl, oxiranyl, glycidyl, alkenyl or alkenyl groups having from 2 to 6 carbon atoms, which with oxiranyl or glycidyl, aryl, heterocyclyl, aralkyl, aralkenyl (aryl-substituted alkenyl), where aryl is as defined above and alkenyl is vinyl, substituted by one or two C₁-C₆-alkyl groups, in which from one to all of the hydrogen atoms, preferably one, has/have been substituted by halogen (preferably fluorine or chlorine if one or more hydrogen atoms has/have been replaced, and preferably fluorine, chlorine or bromine if one hydrogen atom has been replaced), alkenyl groups having 1 to 6 carbon atoms, substituted by from 1 to 3 substituents (preferably 1) selected from the group consisting of C₁-C₄-alkoxy, aryl, heterocyclyl, ketyl, acetyl, amine, amide, oxiranyl, and glycidyl, and m=0 or 1; m=0, 1 or 2. It is preferable that no more than two of the moieties R¹, R², and R³ is/are hydrogen, and it is particularly preferable that at most one of the moieties R¹, R², and R³ is hydrogen.

Among the particularly preferred initiators are benzyl halides, such as p-chloromethylstyrene, hexakis(α-bromomethyl)benzene, benzyl chloride, benzyl bromide, 1-bromo-i-phenylethane and 1-chloro-i-phenylethane. Particular preference is further given to carboxylic acid derivatives halogenated at the α position, e.g. propyl 2-bromopropionate, methyl 2-chloropropionate, ethyl 2-chloropropionate, methyl 2-bromopropionate, or ethyl 2-bromoisobutyrate. Preference is also given to tosyl halides, such as p-toluenesulfonyl chloride; alkyl halides, such as tetrachloromethane, tribromoethane, 1-vinylethyl chloride, or 1-vinylethyl bromide; and halogen derivatives of phosphoric esters, e.g. dimethylphosphonyl chloride.

One particular group of the initiators suitable for the synthesis of block copolymers is provided by the macroinitiators. A feature of these is that from 1 to 3, preferably from 1 to 2, and very particularly preferably one, moiety from the group of R¹, R², and R³ involves macromolecular moieties. These macromoieties can have been selected from the group of the polyolefins, such as polyethylene or polypropylene; polysiloxanes; polyethers, such as polyethylene oxide or polypropylene oxide; polyesters, such as polylactic acid, or from other known end group functionalizable macromolecules. The molecular weight of each of these macromolecular moieties can be from 500 to 100 000, preferably from 1000 to 50 000, and particularly preferably from 1500 to 20 000. It is also possible, for the initiation of the ATRP, to use said macromolecules which at both ends have groups suitable as initiator, e.g. in the form of a bromotelechelic compound. Using macroinitiators of this type it is possible to construct ABA triblock copolymers.

Another important group of the initiators is provided by the bi- or polyfunctional initiators. Using polyfunctional initiator molecules it is, for example, possible to synthesize star polymers. Using bifunctional initiators, it is possible to prepare tri- or pentablock copolymers and telechelic polymers. Bifunctional initiators that can be used are RO₂C—CHX—(CH₂)ₙ—CHX—CO₂R, RO₂C—C(CH₃)X—(CH₂)ₙ—C(CH₃)X—CO₂R, RO₂C—CX₂—(CH₂)ₙ—CX₂—CO₂R, RC(O)—CHX—(CH₂)ₙ—CHX—C(O)R, RC(O)—C(CH₃)X—(CH₂)ₙ—C(CH)₃X—C(O)R, RC(O)—CX₂—(CH₂)ₙ—CX₂—C(O)R, XCH₂—CO₂—(CH₂)ₙ—OC(O)CH₂X, CH₃CHX—CO₂—(CH₂)ₙ—OC(O)CHXCH₃, (CH₃)₂CX—CO₂—(CH₂)ₙ—OC(O)CX(CH₃)₂, X₂CH—CO₂—(CH₂)ₙ—OC(O)CHX₂, CH₃CX₂—CO₂—(CH₂)ₙ—OC(O)CX₂CH₃, XCH₂C(O)C(O)CH₂X, CH₃CHXC(O)C(O)CHXCH₃, XC(CH₃)₂C(O)C(O)CX(CH₃)₂, X₂CHC(O)C(O)CHX₂, CH₃CX₂C(O)C(O)CX₂CH₃, XCH₂—C(O)—CH₂X, CH₃—CHX—C(O)—CHX—CH₃, CX(CH₃)₂—C(O)—CX(CH₃)₂, X₂CH—C(O)—CHX₂, C₆H₅—CHX—(CH₂)ₙ—CHX—C₆H₅, C₆H₅—CX₂—(CH₂)ₙ—CX₂—C₆H₅, C₆H₅—CX₂—(CH₂)ₙ—CX₂—C₆H₅, o-, m-, or p-XCH₂-Ph-CH₂X, o-, m-, or p-CH₃CHX-Ph-CHXCH₃, o-, m-, or p-(CH₃)₂CX-Ph-CX(CH₃)₂, o-, m-, or p-CH₃CX₂-Ph-CX₂CH₃, o-, m-, or p-X₂CH-Ph-CHX₂, o-, m-, or p-XCH₂—CO₂-Ph-OC(O)CH₂X, o-, m-, or p-CH₃CHX—CO₂-Ph-OC(O)CHXCH₃, o-, m-, or p-(CH₃)₂CX—CO₂-Ph-OC(O)CX(CH₃)₂, CH₃CX₂—CO₂-Ph-OC(O)CX₂CH₃, o-, m-, or p-X₂CH—CO₂-Ph-OC(O)CHX₂, or o-, m-, or p-XSO₂-Ph-SO₂X (X being chlorine, bromine, or iodine; Ph being phenylene (C₆H₄); R representing an aliphatic moiety of from 1 to 20 carbon atoms, of linear, branched, or cyclic structure, which can be saturated or have mono- or polyunsaturation, and which can contain one or more aromatic systems or can be free from aromatic systems, and n is a number from 0 to 20). It is preferable to use 1,4-butanediol di(2-bromo-2-methylpropionate), ethylene glycol 1,2-di(2-bromo-2-methylpropionate), diethyl 2,5-dibromoadipate, or diethyl 2,3-dibromomaleate. The subsequent molecular weight is the result of the initiator to monomer ratio, if all of the monomer is converted.

Catalysts for ATPR are listed in Chem. Rev. 2001, 101, 2921. Copper complexes are mainly described—however, other compounds used inter alia are iron compounds, cobalt compounds, chromium compounds, manganese compounds, molybdenum compounds, silver compounds, zinc compounds, palladium compounds, rhodium compounds, platinum compounds, ruthenium compounds, iridium compounds, ytterbium compounds, samarium compounds, rhenium compounds, and/or nickel compounds. It is generally possible to use any of the transition metal compounds which can form a redox cycle with the initiator or, respectively, the polymer chain which has a transferable atom group. By way of example, copper introduced into the system for this purpose can derive from Cu₂O, CuBr, CuCl, CuI, CuN₃, CuSCN, CuCN, CuNO₂, CuNO₃, CuBF₄, Cu(CH₃COO), or Cu(CF₃COO).

An alternative to the ATRP described is provided by a variant of the same: in what is known as reverse ATRP, compounds in higher oxidation states, such as CuBr₂, CuCl₂, CuO, CrCl₃, Fe₂O₃, or FeBr₃ can be used. In these instances, the reaction can be initiated with the aid of traditional radical generators, such as AlBN. Here, the transition metal compounds are first reduced, since they are reacted with the radicals generated by the traditional radical generators. Reverse ATRP was described inter alia by Wang and Matyjaszewski in Macromolekules (1995), vol. 28, pp. 7572ff.

A variant of reverse ATRP is provided by the additional use of metal in the oxidation state zero. The reaction rate is accelerated by what is assumed to be comproportionation with the transition metal compounds of the higher oxidation state. More details of this process are described in WO 98/40415.

The molar ratio of transition metal to monofunctional initiator is generally in the range from 0.01:1 to 10:1, preferably in the range from 0.1:1 to 3:1, and particularly preferably in the range from 0.5:1 to 2:1, with no intention of any resultant restriction.

The molar ratio of transition metal to bifunctional initiator is generally in the range from 0.02:1 to 20:1, preferably in the range from 0.2:1 to 6:1, and particularly preferably in the range from 1:1 to 4:1, with no intention of any resultant restriction.

In order to raise the solubility of the metals in organic solvents and simultaneously to avoid the formation of organometallic compounds which are more stable and therefore less active in polymerization, ligands are added to the system. The ligands also facilitate the abstraction of the transferable atom group by the transition metal compound. A list of known ligands is found by way of example in WO 97/18247, WO 97/47661, or WO 98/40415. The compounds used as ligand mostly have one or more nitrogen atoms, oxygen atoms, phosphorus atoms, and/or sulfur atoms as coordinative constituent. Particular preference is given here to nitrogen-containing compounds. Very particular preference is given to nitrogen-containing chelating ligands. Examples that may be mentioned are 2,2′-bipyridine, N,N,N′,N″,N″-pentamethyldiethylenetriamine (PMDETA), tris(2-aminoethyl)amine (TREN), N,N,N′,N′-tetramethylethylenediamine, or 1,1,4,7,10,10-hexamethyltriethylenetetramine. The person skilled in the art will find in WO 98/40415 useful indications of the selection and combination of the individual components.

These ligands can form coordination compounds in situ with the metal compounds, or they can be first prepared in the form of coordination compounds and then added to the reaction mixture.

The ratio of ligand (L) to transition metal depends on the number of coordination sites occupied by the ligand and on the coordination number of the transition metal (M). The molar ratio is generally in the range from 100:1 to 0.1:1, preferably from 6:1 to 0.1:1, and particularly preferably from 3:1 to 1:1, with no intention of any resultant restriction.

The decisive factor for the present invention is that the ligands are protonatable.

Preference is given to ligands present in the coordination compound in a ratio of 1:1 with respect to the transition metal. If ligands such as 2,2′-bipyridine are used, bonded in the complex in a ratio of 2:1 with respect to the transition metal, complete protonation can take place only if the amount used of the transition metal is markedly substoichiometric, for example 1:2 with respect to the active chain end X. However, this type of polymerization would be severely slowed in comparison with one using equivalent complex-X ratios.

The products worked up as in the invention have a broad field of application. The selection of the examples does not restrict the use of the polymers of the invention. The examples are intended solely to serve as spot tests of the wide applicability of the polymers described. By way of example, ATRP-synthesized polymers are used as prepolymers in hot melt and other adhesive compositions, and in hot melt and other sealing compositions, for polymer-analogous reactions, or to construct block copolymers. The polymers can also be used in formulations for cosmetic use, in coating materials, in lacquers, or as dispersing agents, or as polymer additive, or in packaging.

The examples given below are given to provide better illustration of the present invention, but do not restrict the invention to the features disclosed therein.

### EXAMPLES

### Inventive Example 1

15 g of n-butyl acrylate, 15.5 g of butyl acetate, 0.2 g of copper(I) oxide, and 0.5 g of PMDETA were used as initial charge in a twin-walled vessel equipped with stirrer, thermometer, reflux condenser, nitrogen inlet tube, and dropping funnel, under N₂. The solution is stirred at 60° C. for 15 min. 0.49 g of butanediol 1,4-di(2-bromo-2-methylpropionate) was then added at the same temperature. The mixture is stirred at 70° C. for a polymerization time of 4 hours. After introduction of atmospheric oxygen for about 5 min to terminate the reaction, 0.6 g of n-dodecyl mercaptan is added. The solution, previously greenish, spontaneously assumes a red color, and a red precipitate is formed. Pressure filtration is used for the filtration process. The filter cake assumes a black color within a few hours. The average molecular weight and molecular weight distribution of the polymer in the filtrate are finally determined by GPC measurements. Copper content of a dried specimen of the filtrate is then determined by AAS.

8 g of Tonsil Optimum 210 FF (Südchemie) is admixed with the remaining solution, which is stirred for 30 min and then subjected to pressurized filtration by way of an activated charcoal filter (AKS 5 from Pall Seitz Schenk). This fraction, too, is used for determination of copper content on a dried specimen by AAS, and for a GPC measurement.

After 12 h, a colorless, waxy precipitate forms on the base of the vessel with the filtered polymer solution. This precipitate, too, is characterized by ¹H NMR spectroscopy, IR spectroscopy, ion chromatography, elemental analysis, AAS, and GPC.

### Comparative Example 1

15 g of n-butyl acrylate, 15.5 g of butyl acetate, 0.2 g of copper(I) oxide, and 0.5 g of PMDETA were used as initial charge in a twin-walled vessel equipped with stirrer, thermometer, reflux condenser, nitrogen inlet tube, and dropping funnel, under N₂. The solution is stirred at 60° C. for 15 min. 0.48 g of butanediol 1,4-di(2-bromo-2-methylpropionate) was then added at the same temperature. The mixture is stirred at 70° C. for a polymerization time of 4 hours. After introduction of atmospheric oxygen for about 5 min to terminate the reaction, 8 g of Tonsil Optimum 210 FF (Südchemie) and 4% by weight of water are added to the solution, which is stirred for 60 min. Pressurized filtration then follows through an activated charcoal filter (AKS 5 from Pall Seitz Schenk). The average molecular weight and molecular weight distribution of the polymer in the filtrate are finally determined by GPC measurements. Copper content of a dried specimen of the filtrate is then determined by AAS.

### Inventive Example 2

10 g of methyl methacrylate, 15.8 g of butyl acetate, 0.2 g of copper(I) oxide, and 0.5 g of PMDETA were used as initial charge in a twin-walled vessel equipped with stirrer, thermometer, reflux condenser, nitrogen inlet tube, and dropping funnel, under N₂. The solution is stirred at 60° C. for 15 min. 0.47 g of butanediol 1,4-di(2-bromo-2-methylpropionate) was then added at the same temperature. The mixture is stirred at 70° C. for a polymerization time of 4 hours. After introduction of atmospheric oxygen for about 5 min to terminate the reaction, 0.6 g of n-dodecyl mercaptan is added. The solution, previously greenish, spontaneously assumes a red color, and a red precipitate is formed. Pressure filtration is used for the filtration process. The filter cake assumes a black color within a few hours. The average molecular weight and molecular weight distribution of the polymer in the filtrate are finally determined by GPC measurements. Copper content of a dried specimen of the filtrate is then determined by AAS.

8 g of Tonsil Optimum 210 FF (Südchemie) is admixed with the remaining solution, which is stirred for 30 min and then subjected to pressurized filtration by way of an activated charcoal filter (AKS 5 from Pall Seitz Schenk). This fraction, too, is used for determination of copper content on a dried specimen by AAS, and for a GPC measurement.

After 12 h, a colorless, waxy precipitate forms on the base of the vessel with the filtered polymer solution. This precipitate, too, is characterized by ¹H NMR spectroscopy, IR spectroscopy, ion chromatography, elemental analysis, AAS, and GPC.

### Comparative Example 2

10 g of methyl methacrylate, 15.8 g of butyl acetate, 0.2 g of copper(I) oxide, and 0.5 g of PMDETA were used as initial charge in a twin-walled vessel equipped with stirrer, thermometer, reflux condenser, nitrogen inlet tube, and dropping funnel, under N₂. The solution is stirred at 60° C. for 15 min. 0.47 g of butanediol 1,4-di(2-bromo-2-methylpropionate) was then added at the same temperature. The mixture is stirred at 70° C. for a polymerization time of 4 hours. After introduction of atmospheric oxygen for about 5 min to terminate the reaction, 8 g of Tonsil Optimum 210 FF (Südchemie) and 4% by weight of water are added to the solution, which is stirred for 60 min. Pressurized filtration then follows through an activated charcoal filter (AKS 5 from Pall Seitz Schenk). The average molecular weight and molecular weight distribution of the polymer in the filtrate are finally determined by GPC measurements. Copper content of a dried specimen of the filtrate is then determined by AAS.

TABLE 1

| | Example | | | |
|---|---|---|---|---|
| | Inventive | | Inventive | |
| | example 2 | Comparison 1 | example 3 | Comparison 2 |
| Monomer | n-BA | n-BA | MMA | MMA |
| Cu concentration | ca. 5.5 mg/g | | | |
| (polymerization) | | | | |
| Sulfur compound | n-DDM | — | n-DDM | — |
| Adsorbent | — | Alox/Silica | — | Alox/Silica |
| Cu concentration | 0.5 μg/g | 44 μg/g | 0.2 μg/g | 22 μg/g |
| (1st filtration) | | | | |
| Adsorbent | Alox/silica/ | Alox/silica/ | Alox/silica/ | Alox/silica/ |
| | activated | activated | activated | activated |
| | charcoal filt. | charcoal filt. | charcoal filt. | charcoal filt. |
| Cu concentration | 0.2 μg/g | 10 μg/g | 0.09 μg/g | 4 μg/g |
| (2nd filtration) | | | | |
| Equivalents with | 1.4 | — | 1.8 | — |
| respect to Cu | | | | |
| Mₙ | 8900 | 9800 | 10 100 | 9300 |
| (before purification) | | | | |
| M_{w}/Mₙ | 1.20 | 1.18 | 1.20 | 1.17 |
| (before purification) | | | | |
| Mₙ | 8900 | 9800 | 10 200 | 9400 |
| (after purification) | | | | |
| M_{w}/Mₙ | 1.19 | 1.18 | 1.21 | 1.16 |
| (after purification) | | | | |

MMA = methyl methacrylate; n-BA = n-butyl acrylate; n-DDM = n-dodecyl mercaptan; Alox = aluminum oxide;

The examples clearly show that the results, themselves very good, with adsorbents for removal of transition metal complexes (in this case copper complexes) from polymer solutions can be clearly improved through preceding precipitation using sulfur compounds.

The present examples are based on the ATRP process. The polymerization parameters here were selected in such a way that operations required particularly high copper concentrations: low molecular weight, 50% strength solution, and bifunctional initiator.

The results for inventive example 1 show that even when a very small excess is used of corresponding sulfur compounds, based on the transition metal compound, the result is very efficient precipitation. The examples also show that all of the thiol-functionalized reagents can realize more efficient removal of the transition metal compounds from the solution than can be achieved even through optimized work-up using adsorbents.

The residual sulfur contents given in the table themselves show fully satisfactory removal. Variation within the context of the process of the invention can moreover realize an increase in removal efficiency.

Comparison of the molecular weight and molecular weight distributions prior to and after work-up in all of the examples and comparative examples reveals that the methods applied have no effect on the characteristics of the polymer with the exception of substitution of the end groups.

Substitution of the end groups is demonstrated in a number of ways by characterizing various constituents of the worked-up polymer solution 1.) the copper precipitate: the red precipitate that forms on addition of the sulfur reagents has an extremely low sulfur content, at <10 ppm, and precipitation of the metal in the form of sulfide can therefore be excluded.

2.) The polymer: elemental analysis reveals very high sulfur content of the polymer solution, even after removal of the second, colorless precipitate. Almost all of the sulfur added to the system is in turn found in the solution, and respectively in the dried product.

3.) The second, colorless precipitate: ¹H NMR studies, and also IR spectroscopy, revealed that the precipitate involve the ammonium salt of the singly protonated triamine PMDETA. Elemental analysis revealed that said precipitate is sulfur-free. Bromide content of from 32% by weight to 37% by weight is demonstrated by ion chromatography, as a function of sample. This value corresponds to the content in a pure PMDETA-ammonium bromide.

What is claimed is

1. A process for the removal of halogen atoms from polymers and removal of transition metal compounds, characterized in that the halogen atoms are substituted by addition of a suitable sulfur compound and simultaneously the transition metal compounds are precipitated by said sulfur compound, and are then removed by filtration.

2. The process for the work-up of polymer solutions, as claimed in claim 1, characterized in that the sulfur compound involves a mercaptan or another organic compound having a thiol group.

3. The process for the work-up of polymer solutions, as claimed in claim 1, characterized in that the sulfur compound involves a regulator familiar in free-radical polymerization technology.

4. The process for the work-up of polymer solutions, as claimed in claim 1, characterized in that said sulfur compound has an additional functionality.

5. The process for the work-up of polymer solutions, as claimed in claim 4, characterized in that said further functionality involves a hydroxy group, acid group, or amine group.

6. The process for the work-up of polymer solutions, as claimed in claim 1, characterized in that the sulfur compound involves n-dodecyl mercaptan, methyl mercaptan, ethyl mercaptan, butyl mercaptan, ethylhexyl mercaptan, isooctyl mercaptan, tert-dodecyl mercaptan, thioglycolacetic acid, mercaptopropionic acid, mercaptoethanol, mercaptopropanol, mercaptobutanol, mercaptohexanol, or octyl thioglycolate.

7. The process for the work-up of polymer solutions, as claimed in claim 1, characterized in that the sulfur compound is added after or during the termination of a polymerization.

8. The process for the work-up of polymer solutions, as claimed in claim 1, characterized in that, based on the concentration of the chain ends previously active in polymerization, 1.5 molar equivalents of the sulfur compound are used.

9. The process for the work-up of polymer solutions, as claimed in claim 8, characterized in that, based on the concentration of the chain ends previously active in polymerization, 1.1 molar equivalents of the sulfur compound are used.

10. The process for the work-up of polymer solutions, as claimed in claim 1, characterized in that this involves the polymerization by the ATRP process.

11. The process as claimed in claim 1, characterized in that the transition metal compound used as catalyst in the polymerization involves copper compounds, iron compounds, cobalt compounds, chromium compounds, manganese compounds, molybdenum compounds, silver compounds, zinc compounds, palladium compounds, rhodium compounds, platinum compounds, ruthenium compounds, iridium compounds, ytterbium compounds, samarium compounds, rhenium compounds and/or nickel compounds.

12. The process as claimed in claim 11, characterized in that the transition metal compound used as catalyst in the polymerization involves a copper compound.

13. The process as claimed in claim 12, characterized in that the copper compound was added to the system in the form of Cu₂O, CuBr, CuCl, CuI, CuN₃, CuSCN, CuCN, CuNO₂, CuNO₃, CuBF₄, Cu(CH₃COO) and/or Cu(CF₃COO), prior to the start of the polymerization.

14. The process as claimed in claim 1, characterized in that the preceding polymerization uses an initiator which has an active group X.

15. The process as claimed in claim 14, characterized in that the active group X involves Cl, Br, I, SCN and/or N₃.

16. The process as claimed in claim 15, characterized in that, in relation to the active groups, the initiator can be mono-, di-, or polyfunctional.

17. The process as claimed in claim 14, characterized in that the active group X at the end of the polymer chain is substituted by the sulfur compound to give a thioether, with liberation of an acid of type X—H.

18. The process as claimed in claim 1, characterized in that, prior to the polymerization, the catalyst is combined with a nitrogen-, oxygen-, sulfur-, or phosphorus-containing compound which can form one or more coordinative bonds to the transition metal, to give a metal-ligand complex.

19. The process as claimed in claim 18, characterized in that the ligands used comprise N-containing chelating ligands.

20. The process as claimed in claim 18, characterized in that the ligand is protonated by the acid X—H.

21. The process as claimed in claim 20, characterized in that the protonation releases the ligand from the coordinated transition metal.

22. The process as claimed in claim 21, characterized in that the removal of the ligand precipitates the transition metal.

23. The process as claimed in claim 1, characterized in that the polymer is obtainable through polymerization of alkyl acrylates, of alkyl methacrylates, of styrenes, of vinyl esters, of vinyl ethers, of fumarates, of maleates, of itaconates, of acrylonitriles and/or of other monomers polymerizable by ATRP, and/or mixtures composed of alkyl acrylates, of alkyl methacrylates, of vinyl esters, of vinyl ethers, of fumarates, of maleates, of itaconates, of styrenes, of acrylonitriles, and/or of other monomers polymerizable by ATRP.

24. The process as claimed in claim 1, characterized in that the polymer is obtainable through polymerization of styrenes, of alkyl acrylates, and/or of alkyl methacrylates, and/or mixtures composed mainly of styrenes, of alkyl acrylates, and/or of alkyl methacrylates.

25. The process according to claim 1, characterized in that the precipitation and the subsequent filtration reduce the metal content in the polymer solution by at least 80%.

26. The process according to claim 25, characterized in that the precipitation and the subsequent filtration reduce the metal content in the polymer solution by at least 95%.

27. A polymer prepared by the process as claimed in claim 1, characterized in that it has been prepared by ATRP, its polydispersity is smaller than 1.5, its halogen content is smaller than 0.1% by weight, and it has at least one thioether group at one of the chain ends.

28. A linear polymer as claimed in claim 27, characterized in that it has been prepared using a bifunctional initiator, its halogen content is smaller than 0.1% by weight, and it has a thioether group at both chain ends.

29. The linear polymer as claimed in claim 28, characterized in that it has been prepared using a bifunctional initiator, its halogen content is smaller than 0.01% by weight, and it has a thioether group at both chain ends.

30. The use, in hot-melt or other adhesive compositions, or hot-melt or other sealing compositions, for polymer-analogous reactions, in cosmetic applications, in coating materials, as dispersing agents, as polymer additive, or in packaging, of the polymers worked-up as claimed in any of the preceding claims.
